(19) United States
(12) Patent Application Publication
(10) Pub. No.: US 2024/0346363 A1
(43) Pub. Date: Oct. 17, 2024

(54) RULE BASED PROCESS FLOW PREDICTION

(71) Applicant: SAP SE, Walldorf (DE)

(72) Inventors: Abhishek Kumar, Bangalore (IN); Anit Nair, Bangalore (IN)

(21) Appl. No.: 18/298,844

(22) Filed: Apr. 11, 2023

(51) Int. Cl. G06N 20/00

(52) U.S. Cl. CPC G06N 20/00

(57) ABSTRACT

Decision logic is determined based on unique branches and the conditions between steps of a process model. The decision logic outputs a next step based on a current step of the process, a previous path traversed, the attributes, and the conditions for the attributes. For a particular instance of the process, a current step a predicted output value for a current step of the instance is determined by providing information on the current step of the instance and a previous path traversed for the instance to a machine learning model. A next step of the process is determined using the decision logic and the predicted output value. A predicted process flow through the plurality of process steps for the instance is determined by iteratively determining subsequent steps for the instance using the machine learning model and the decision logic until reaching an end of the instance of the process.

### BACKGROUND

The present disclosure pertains to process automation software and in particular to combining machine learning prediction with rule-based decisions to predict the flow of a current process instance.

Process automation software may be used to model a process or workflow (e.g., a sequence of connected activities or tasks that are completed to achieve a particular result) such that portions of it may be automated by software. For instance, process automation software may enable a designer to create a process model by establishing the sequence of steps, inputs and outputs to each step, the format for providing such inputs and outputs (e.g., fields or forms), attributes and conditions used for any branching between steps, and more. Robotic process automation may also be integrated in the process to automate repetitive manual tasks that would otherwise be performed by users.

Once the model for a process is designed, various instances of the process may be initiated and worked through to completion. For instance, if the process is a product purchase process, the designed process may include steps a creating a purchase request, selecting a vendor, generating an invoice, etc. Different users may initiate different purchase orders using the same process model.

However, not all instances of a process may go smoothly as some activities may be beyond the user's control. For instance, with a purchase order process it is possible that an approver of the purchase order may be delayed, or they may be unlike to approve the purchase order, or they may require the order to be reworked, for example. It is also possible that a vendor is out of stock of a particular product, or an approver on the vendor's side may be unable or unwilling to accept the order based on timing requirements, for example. It would be advantageous to avoid delays, interruptions, or failure for particular process instances managed using process automation software.

The present disclosure addresses these issue and others, as further described below.

### SUMMARY

In some aspects, the techniques described herein relate to a computer system, including: one or more processors; one or more machine-readable medium coupled to the one or more processors and storing computer program code including sets instructions executable by the one or more processors to: obtain a process model of a process, the process model including inputs, outputs, and attributes for a plurality of process steps; determine unique branches between particular steps of the plurality of process steps and conditions for the attributes associated with the unique branches by traversing the process model; determine decision logic based on the unique branches and the conditions, the decision logic outputting a next step based on a current step of the process, a previous path traversed, the attributes, and the conditions for the attributes; obtain information on a current step of an instance of the process and a previous path traversed for the instance of the process; determine a predicted output value for the current step of the instance of the process by providing the information on the current step of the instance and the previous path traversed for the instance to a machine learning model; determine a next step for the instance of the process using the decision logic and the predicted output value; determine a predicted process flow through the plurality of process steps for the instance of the process by iteratively determining subsequent steps for the instance by predicting output values using the machine learning model and determining the following step using the decision logic until reaching an end of the instance of the process; and present the predicted process flow in a user interface along with the predicted output values and conditions.

In some aspects, the techniques described herein relate to one or more non-transitory computer-readable medium storing computer program code including sets of instructions to: obtain a process model of a process, the process model including inputs, outputs, and attributes for a plurality of process steps; determine unique branches between particular steps of the plurality of process steps and conditions for the attributes associated with the unique branches by traversing the process model; determine decision logic based on the unique branches and the conditions, the decision logic outputting a next step based on a current step of the process, a previous path traversed, the attributes, and the conditions for the attributes; obtain information on a current step of an instance of the process and a previous path traversed for the instance of the process; determine a predicted output value for the current step of the instance of the process by providing the information on the current step of the instance and the previous path traversed for the instance to a machine learning model; determine a next step for the instance of the process using the decision logic and the predicted output value; determine a predicted process flow through the plurality of process steps for the instance of the process by iteratively determining subsequent steps for the instance by predicting output values using the machine learning model and determining the following step using the decision logic until reaching an end of the instance of the process; and present the predicted process flow in a user interface along with the predicted output values and conditions.

In some aspects, the techniques described herein relate to a computer-implemented method, including: obtaining a process model of a process, the process model including inputs, outputs, and attributes for a plurality of process steps; determining unique branches between particular steps of the plurality of process steps and conditions for the attributes associated with the unique branches by traversing the process model; determining decision logic based on the unique branches and the conditions, the decision logic outputting a next step based on a current step of the process, a previous path traversed, the attributes, and the conditions for the attributes; obtaining information on a current step of an instance of the process and a previous path traversed for the instance of the process; determining a predicted output value for the current step of the instance of the process by providing the information on the current step of the instance and the previous path traversed for the instance to a machine learning model; determining a next step for the instance of the process using the decision logic and the predicted output value; determining a predicted process flow through the plurality of process steps for the instance of the process by iteratively determining subsequent steps for the instance by predicting output values using the machine learning model and determining the following step using the decision logic until reaching an end of the instance of the process; and presenting the predicted process flow in a user interface along with the predicted output values and conditions.

The following detailed description and accompanying drawings provide a better understanding of the nature and advantages of the present disclosure.

### BRIEF DESCRIPTION OF THE DRAWINGS

FIG. 1 shows a diagram of a purchase order process workflow, according to an embodiment.

FIG. 2 shows a diagram of a rule based process flow prediction system, according to an embodiment.

FIG. 3 shows a diagram of a method for rule based process flow prediction, according to an embodiment.

FIG. 4 shows a diagram of a rule based process flow prediction architecture, according to an embodiment.

FIG. 5 shows a diagram of hardware of a special purpose computing machine for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident, based on the language of the different claims, that the claimed subject matter may include some or all of the features in these examples, alone or in combination, and may further include modifications and equivalents of the features and techniques described herein.

In the figures and their corresponding description, while certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. As used herein, the terms “first,” “second,” “third,” “fourth,” etc., do not necessarily indicate an ordering or sequence unless indicated. These terms, as used herein, may simply be used for differentiation between different objects or elements.

As mentioned above, process automation software may be used to model a process or workflow (e.g., a sequence of connected activities or tasks that are completed to achieve a particular result) such that portions of it may be automated by software. For instance, process automation software may enable a designer to create a process model by establishing the sequence of steps, inputs and outputs to each step, the format for providing such inputs and outputs (e.g., fields or forms), attributes (e.g., values of certain fields) and conditions used for any branching between steps, and more. Robotic process automation may also be integrated in the process to automate repetitive manual tasks that would otherwise be performed by users.

Once the model for a process is designed, various instances of the process may be initiated and worked through to completion. For instance, if the process is a product purchase process, the designed process may include steps a creating a purchase request, selecting a vendor, generating an invoice, etc. Different users may initiate different purchase orders using the same process model. Process automation software can also provide a visibility user interface for reviewing the status and prior activities of current and past process instances.

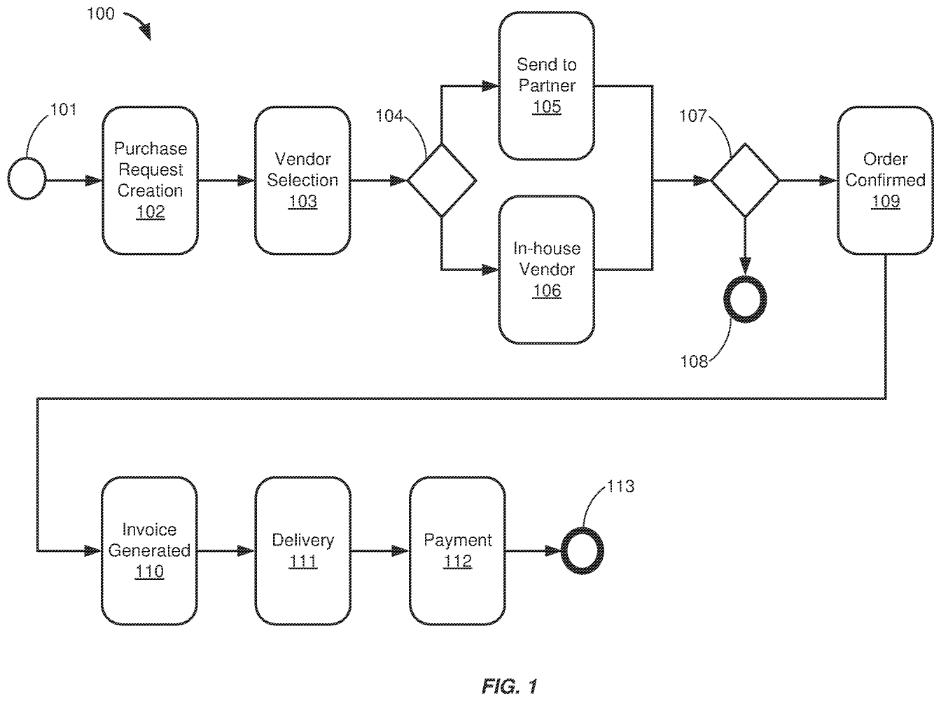

However, not all instances of a process may go smoothly as some activities may be beyond the user's control. For instance, with a purchase order process it is possible that an approver of the purchase order may be delayed, or they may be unlike to approve the purchase order, or they may require the order to be reworked, for example. It is also possible that a vendor is out of stock of a particular product, or an approver on the vendor's side may be unable or unwilling to accept the order based on timing requirements, for example. An example process is described below with respect to FIG. 1. The present disclosure provides techniques for rule based process flow prediction, which may be presented to a user within a process visibility user interface of process automation software to enable them to mitigate, avoid, or at least be notified of possible delay, interruption, or failure for particular process instances.

An example process workflow is described before providing details on the techniques for rule based process flow prediction, FIG. 1 shows a diagram 100 of a purchase order process workflow, according to an embodiment. This process includes a sequence of connected steps (e.g., activities or tasks) that are completed to achieve a particular result. In this case the result is purchasing the items in a purchase order.

Process automation software may be used to design the workflow shown in diagram 100 of FIG. 1. For instance, the software may provide a user interface for dragging and dropping workflow steps, activities, tasks, decisions, paths, and so forth onto a canvas on a user interface. The process automation software may enable the user to define inputs and outputs for each step as well as attributes (e.g., attributes of the input, or time-based attributes) used to determine the output values. The process workflow designed by a user of the process automation software may be stored as a process model (e.g., data artifact, object, or other structure), which may be used to create specific instances of the process workflow. For example, a purchase order process model may be used to creature purchase order instances for a particular purchase order requested using a purchase request. This purchase order workflow example is now described in detail.

At step 101 the purchase order workflow begins. This workflow may begin in response to an input from a user (e.g., to a user interface of the process automation software) triggering this workflow. A user may input a set or list of Order Items to be purchased. Each item in the Order Items may have a Product Category and a Product Amount.

A Purchase Request Creation step 102 receives the Order Items as input. A Purchase Request Document and a Vendor List may be determined based on the Product Category attribute and the Product Amount attribute. The Purchase Request Document may be a document indicating a request to purchase the Order Items which may be sent to a vendor or partner. The Vendor List may be a list of possible vendors and partners and may indicate a Vendor Rating for each of the vendors and partners. The output of the Purchase Request Creation step 102 is the Purchase Request Document and the Vendor List.

Next, a Vendor Selection step 103 receives the Purchase Request Document and the Vendor List from the Purchase Request Creation step 102. The Vendor Selection step 103 may select a Vendor based on one or more attributes including a Vendor Rating attribute, The Product Category attribute, and the Product Amount attribute. The output of the Vendor Selection step 103 is the selected Vendor and the Purchase Request Document.

At step 104 the purchase order workflow branches to either step 105 (Send to Partner) or step 106 (In-house Vendor) depending on the selected Vendor, which is the output of the Vendor Selection step 103. If the selected Vendor is a partner, the workflow continues with step 105. If the selected Vendor is an in-house vendor, the workflow continues with step 106.

The Send to Partner step 105 receives the Purchase Request Document as input (from step 103) and determines a Purchase Order Status based on one or more attributes including the Order Items attribute, the Order Quantity attribute, a Transaction Date attribute, and a Vendor Category attribute. The Purchase Order Status is the output of the Send to Partner step 105.

The In-house Vendor step 105 receives the Purchase Request Document as input (from step 103) and determines a Purchase Order Status based on one or more attributes including the Order Items attribute, the Order Quantity attribute, a Transaction Date attribute, and a Vendor Category attribute. The Purchase Order Status is the output of the In-house Vendor step 106.

At 107 the Purchase Order Status output from either the Send to Partner step 105 or the In-house Vendor step 106 is used to determine whether to end the process at step 108 or to continue to the Order Confirmed Step 109. For example, the order status may indicate that the order is “confirmed” or “accepted.” In these cases the process may continue to the Order Confirmed step 109. If the order status is “denied” then the purchase order process may end at 108.

The Order Confirmed step 109 may receive the Purchase Order Status and the Purchase Request Document as input. The Order Confirmed step 109 may output the Purchase Order Document based on the Purchase Order Status attribute.

Next, an Invoice Generated step 110 receives the Purchase Order Document as input. The Invoice Generated step 110 outputs an Invoice Document and a Delivery Document.

Next, a Delivery step 111 receives the Delivery Document and the Invoice Document as input. The Delivery step 111 outputs a Delivery Receipt and the Invoice Document.

Next, a Payment step 112 receives the Delivery Receipt and Invoice Document. The Payment step 112 outputs a Payment Receipt. Then the process successfully ends at step

The table below provides the inputs, outputs, and possible decision attributes for the process steps of the purchase order process workflow.

| Process | | | Possible |
|---|---|---|---|
| Step | Input | Output | Decision Attributes |
| Purchase | Order Items | Purchase Request | Product Category, |
| Request | | Document, | Product Amount |
| Creation | | Vendor List | |
| Vendor | Purchase Request | Vendor, | Vendor Rating |
| Selection | Document, | Purchase Request | Product Category, |
| | Vendor List | Document | Product Amount |
| Send to | Purchase Request | Purchase Order | Order Items, |
| Partner | Document | Status | Order Quantity, |
| | | | Transaction Date, |
| | | | Vendor Category |
| In-house | Purchase Request | Purchase Order | Order Items, |
| Vendor | Document | Status | Order Quantity, |
| | | | Transaction Date, |
| | | | Vendor Category |
| Order | Purchase Order | Purchase Order | Purchase Order |
| Confirmed | Status, Purchase | Document | Status |
| | Request Document | | |
| Invoice | Purchase Order | Invoice Document, | |
| Generated | Document | Delivery Document | |
| Delivery | Delivery | Delivery Receipt, | |
| | Document, Invoice | Invoice Document | |
| | Document | | |
| Payment | Delivery Receipt, | Payment Receipt | |
| | Invoice Document | | |

As mentioned above, this purchase order process may be designed using process automation software and portions of this process may be automated by the software based on inputs received from the user. For example, a user may input items and amounts to be purchased into a form and the software may automatically generate the Purchase Request Document, select the Vendor, and then send the Purchase Request Document to the selected partner or vendor, and so on.

Process automation software can be used to automate a process and may enable users to gain real time visibility into running processes. However, the visibility of the process (e.g., its current status, performance indicators, etc.) provided by certain prior process visibility software is “reactive,” in the sense that it tells what has already happened. Certain prior process automation software do not provide a view into the future execution of processes, such as what will be the flow of process, which branches the process will or is likely to traverse in the future, and how a process participant can influence the execution flow of the process. As used herein, “traverse” refers to a sequence of connected steps within a model of a process that have been initiated or performed. The prediction of the flow (e.g., path of steps performed) may help the process participants (e.g., users) to actively manage potential bottleneck situations before they happen.

Referring back to diagram 100 of FIG. 1, the process of a “Purchase Request” can flow through different path and may experience a bottleneck situation either with the “In-house Vendor” (step 106) or with the “Partner” (step 105). For example, a Purchase Request Document may have been created which will be sent to an in-house vendor based on their vendor rating and the Product Category and Product Amount of the Order Items in the Purchase Request Document. However, that particular in-house vendor may experiencing delays in fulfilling orders, or they may require a rework of this particular order, for some reason or another.

In certain prior process automation software, their approach of Visibility into process execution provides visibility of the bottleneck situation once the process reaches to one of the steps: “Send to Partner” (step 105) or “In-house Vendor” (step 106). This results into a reactive action. To help the Process Participants (e.g., user) to take proactive action and avoid bottleneck situation, what is needed is anticipation of the bottleneck situation at earlier stage of process before actually reaching to these steps. In the purchase order example above, in response to the predicted bottleneck situation, the selected vendor/partner can be informed much earlier so that they are ready to avoid any delay, for example. Or in a situation where the vendor is experiencing delays or would require a rework, the Purchase Order can be modified in order to use a different vendor instead, or it may be reworked before the Purchase Request Document is sent to the partner/vendor, thereby avoiding bottlenecks or other delays proactively.

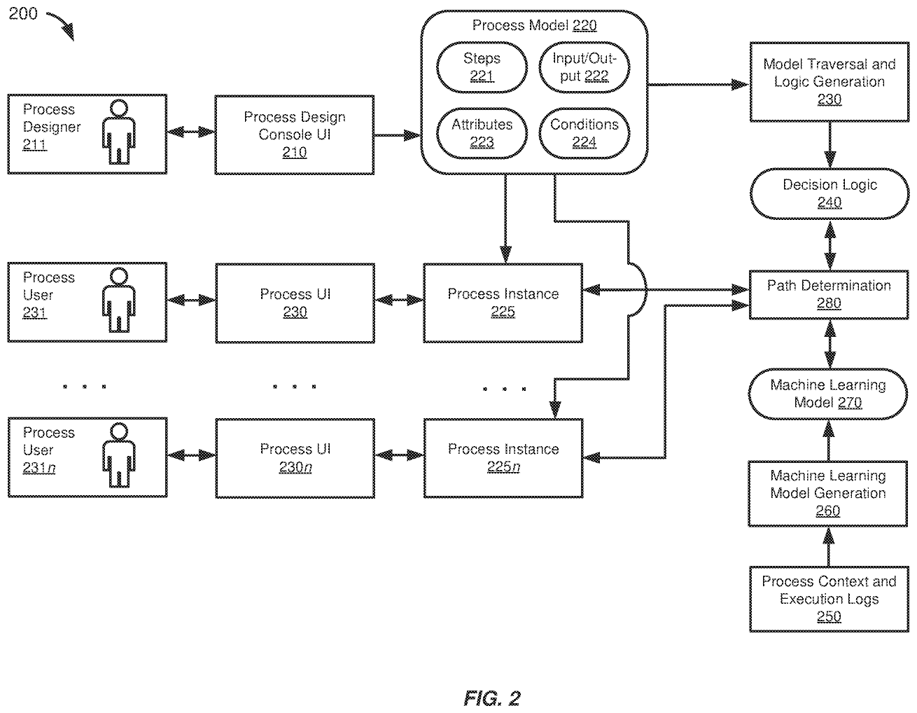

The present disclosure provides techniques for rule based process flow prediction which enable prediction of the future process execution (e.g., the steps through which the process will flow), thereby enabling the process participants to react proactively for their specific instance of the process (i.e., for their specific Purchase Order). FIG. 2 shows a diagram 200 of a rule based process flow prediction system, according to an embodiment.

A process designer user 211 may use a process design console user interface (UI) of process automation software to design a process model 220. The process model 220 includes a plurality of steps 221, inputs/outputs 222 for the plurality of steps, attributes 223, and conditions 224. Examples of eps 221, inputs/outputs 222 for the plurality of steps, attributes 223, and conditions 224 for a purchase order process were described above with respect to FIG. 1.

A model traversal and logic generation module 230 may traverse the process model 220 to determine information about input and output interfaces (e.g., input/output 222) for every step of the process (e.g., steps 221).

The model traversal and logic generation module 230 may also traverse the process model 220 to determine information about the unique possible branches (e.g., unique sequence of connected steps through the process model) and associated conditions (e.g., conditions 224, including any time-based conditions for timer boundary events, or attribute-based conditions for branches and gateways and escalation boundary events).

The model traversal and logic generation module 230 may convert the conditions and the possible paths into Decision Logic 240. In some embodiments the Decision Logic 240 may be a decision table with two inputs: the determined conditions and the previous path traversed (e.g., the sequence of steps up to the current step. The decision table may give an output of the next path traversed (e.g., the next step in the sequence of steps in the process flow). An example of a Decision Logic decision table is given below.

A machine learning model generation module 260 may run a machine learning algorithm on historical execution data (e.g., both process context and execution log) of process instances of the process model 220. The machine learning algorithm and historical data is used to train the machine learning model 270, which is configured to predict a value of an output interface of a step. This predictions may be used to predict the output value of a current step of a process instance whose future execution needs to be predicted. For example, a process user 231 may use a process user interface 230 of process automation software to initiate, manage, and monitor a particular process instance 225 of a process based on the process model 220. Referring back to the Purchase Order example, an “instance” refers to a particular purchase order for a particular set of Order Items. Other users (e.g., process users 321n) may initiate, manage, and monitor their own process instances 225n using their own process UI 230n for other specific purchase orders.

For a particular instance 225 of the process, a path determination module 280 may use the machine learning model 270 to predict a value of the output interface of the current step of the process instance 225. The path determination module 280 may compare the predicted output value to the conditions for that particular step in the decision logic 240 to predict the next step in the process for this process instance 225.

The path determination module 280 may iteratively use the machine learning model 270 to predict the output interface value for the last activity, which is returned from decision logic 240, and compare that predicted output interface value to the decision logic 240 to determine the next step, and then repeat this sub-process until the outcome of decision logic 240 gives the last activity of next path as “End”, “Abrupt,” “Cancel,” or another indication that the process is ended or complete, whether successful or not.

Features and advantages of such rule based process flow prediction include enabling a user to see a predicted flow through the process and be able to proactively take actions to avoid delays or bottlenecks. Furthermore, with rule-based process path forecasting, the running of the machine learning model 270 is optimized to selected steps based on the outcome of the decision logic 240 (e.g., only steps predicted to be taken based on the decision logic are analyzed instead of analyzing all steps of the process). Furthermore, the decision logic provides an intuitive way for a user to influence the process execution by changing the conditions without changing the actual process (e.g., the user may change values by assigning more resources to an activity and thus changing the time-based conditions, or the user may change an amount of a purchase order item, etc.). In addition, the execution log of the decisions provides an intuitive view into what affects the process flow which can be used to further optimize the process.

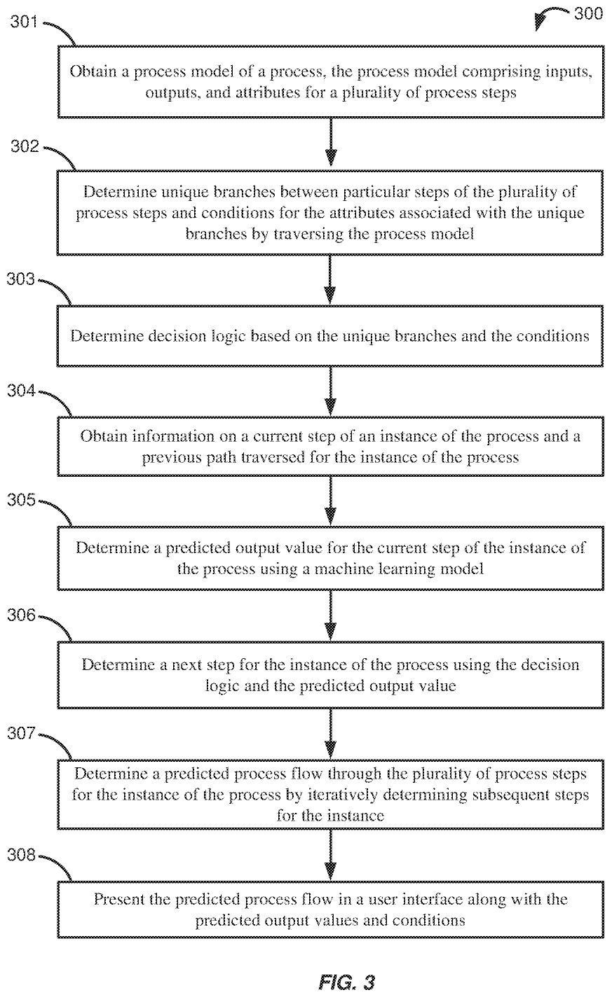

FIG. 3 shows a diagram 300 of a method for rule based process flow prediction, according to an embodiment. The method may be implemented by a rule based process flow prediction system, such as the system described above with respect to FIG. 2.

At 301, obtain a process model of a process, the process model comprising inputs, outputs, and attributes for a plurality of process steps. An example of inputs, outputs, and attributes for a purchase order request was described above with respect to FIG. 1.

At 302, determine unique branches between particular steps of the plurality of process steps and conditions for the attributes associated with the unique branches by traversing the process model. Referring back to the purchase order process of FIG. 1, that process includes a branch to Send to Partner (step 105) and a branch to In-house Vendor (step 106). For those branches the conditions for branching are based on one or more of the following attributes: Order Items, Order Quantity, Transaction Date, and Vendor Category. As examples, the conditions could be particular items, or a particular quantity of item, a particular date, a particular set of vendor categories, etc.

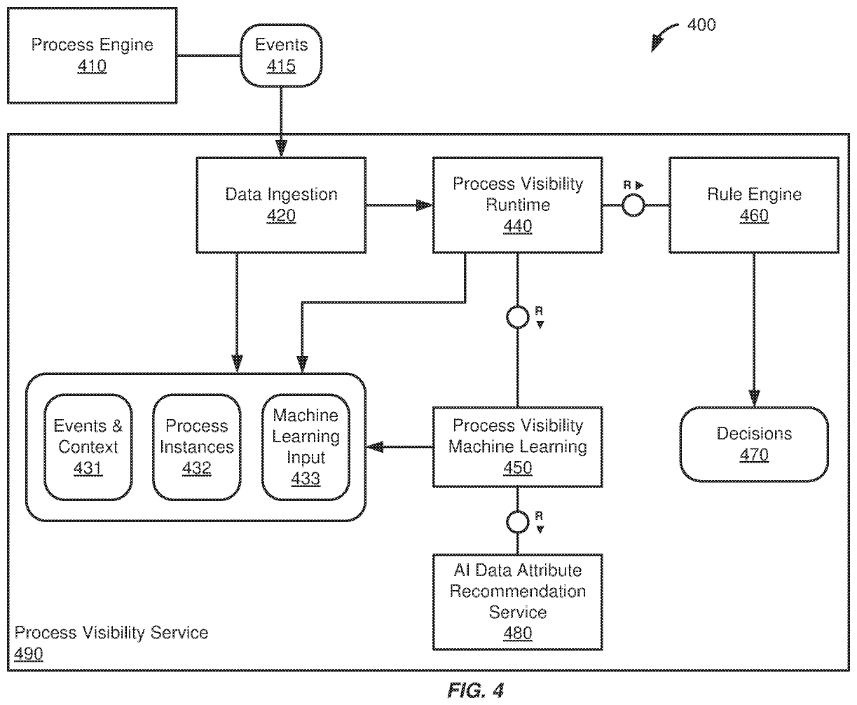

At 303, determine decision logic based on the unique branches and the conditions, the decision logic outputting a next step based on a current step of the process, a previous path traversed, the attributes, and the conditions for the attributes. An example of decision logic is provided below along with the description of FIG. 4.

At 304, obtain information on a current step of an instance of the process and a previous path traversed for the instance of the process. In the purchase order example, the “instance” of the process refers to a particular purchase order for a particular set of Order Items, which uses the purchase order process shown in diagram 100 of FIG. 1. The information on the current step may include an identifier of the current step of the process, a previous path traversed, the attributes, and the conditions for the attributes.

At 305, determine a predicted output value for the current step of the instance of the process by providing the information on the current step of the instance and the previous path traversed for the instance to a machine learning model. The machine learning model may be trained based on execution logs and historical data for a plurality of historical process instances of the process model.

In some embodiments the method may also obtain execution logs and historical data for a plurality of historical process instances of the process model. They method may also initiate training of the machine learning model using the execution logs and historical data. In some embodiments the execution logs and historical data for the plurality of historical process instances include statuses, timestamps, input values, and output values for the plurality of process steps, wherein the machine learning model predicts output values for a particular process step based on provided input values.

In some embodiments the method may also remove duplicates and incomplete instances from the execution logs and historical data to obtain cleansed training data. The method may also group the cleansed training data per process step of the plurality of process step, wherein the training of the machine learning model uses the cleansed training data grouped per process step.

At 306, determine a next step for the instance of the process using the decision logic and the predicted output value. The example decision logic given below provides examples conditions and next steps (next action). For example, if the current step is Vendor Selection and the Product Category attribute is “IT,” and the Amount is less than 1000 EUR, then the next step is “In-house Vendor.” But if the Amount is greater than 1000 EUR then the next step is “Send to Partner.” Other examples are provided below.

At 307, determine a predicted process flow through the plurality of process steps for the instance of the process by iteratively determining subsequent steps for the instance by predicting output values using the machine learning model and determining the following step using the decision logic until reaching an end of the instance of the process. For example, the “end” of the instance process may be determined by the next step (as identified using the decision logic) being “End,” “Abrupt,” or “Cancel,” for example.

At 308, present the predicted process flow in a user interface along with the predicted output values and conditions. In some embodiments the method may also provide a notification regarding the predicted process flow for the process instance in the user interface.

In some embodiments, the method may also obtain input via the user interface to adjust the attributes of the instance of the process. The method may also determine another predicted process flow through the plurality of process steps for the instance of the process using the attributes as adjusted, where the other predicted process flow being different than the original predicted process flow. The method may also present the other predicted process flow in the user interface along with the predicted output values and conditions. In some embodiments the input adjusts the attributes of the instance of the process without modifying the process model.

FIG. 4 shows a diagram 400 of a rule based process flow prediction architecture, according to an embodiment. The architecture includes a Process Engine 410, a Data Ingestion component 420, a Process Visibility Runtime 440, a Process Visibility Machine Learning component 450, a Rule Engine 460, Decisions 470, and an Artificial Intelligence (AI) Data Attribute Recommendation service 480.

The Process Engine 410 is configured to execute the process. The Process engine 410 emits events 415, to the Process Visibility service 490, representing the process execution status and changes to data used by the process during the process execution.

The Data Ingestion component 420 receives the events 415 pushed by the Process Engine 410 and updates an Event and Context data store 431. The Data Ingestion component 420 is also configured to create and store process instances 432. The Data Ingestion component 420 is also configured to cleanse and prepare machine learning input 433 for input to the AI Data Attribution Recommendation (DAR) service 480.

The Process Visibility Runtime 440 is configured to correlate the process events and is configured to evaluate defined process performance indicators. The Process Visibility Runtime 440 also is configured to evaluate the Process Path using the AI DAR service 480 and the Decision 470.

The Process Visibility Machine Learning component 450 is configured to interact the AI DAR service 480 and is configured to create, train, and optimize the machine learning model used to predict the process step output interface values.

The Rule Engine 460 is configured to execute the Decisions 470 (e.g., a Decision Table). The Rule Engine 460 provides capability to dynamically update the Decisions 470 based on input from the DAR service 480. In some embodiments, a decision table may be created on-the-fly using a process metamodel. The Rule Engine 460 may also use an embedded mode to gain higher performance and to influence the decision table execution based on the activity information.

An example Decision Table is provided below. This example decision table corresponds to the purchase order process example described above with respect to FIG. 1. As described herein, the output variables provide by the machine model may be used as input to the Decision Table to predict the next step in the process path.

| Condition | Action/Next Step | Comments |
|---|---|---|
| If current_step = ‘Vendor Selection’ & | Inhouse Vendor | |
| product_category = ‘IT’ & amount < ‘1000 | | |
| EUR’ | | |
| If current_step = ‘Vendor Selection’ & | Send to Partner | |
| product_category = ‘IT’ & amount > ‘1000 | | |
| EUR’ | | |
| If current_step = ‘Inhouse Vendor & | Purchase Request | |
| product_category = ‘IT’ & amount > ‘1000 | Creation | |
| EUR’ or quantity > 10 | | |
| If current_step = ‘Inhouse Vendor & | Order Confirmed | |
| product_category = ‘IT’ & amount < ‘1000 | | |
| EUR’ or quantity < 10 | | |
| If current_step = ‘Send to Partner’ & | Process Ends— | Only Gold and Platinum |
| product_category = ‘IT’ & amount > | Order Rejected | Category Vendors have history |
| ‘10000 EUR’ & vendor_category = ‘silver’ | | of processing high valued |
| | | orders. |
| If current_step = ‘Send to Partner’ & | Process Ends— | Only Gold and Platinum |
| product_category = ‘IT’ & amount > | Order Rejected | Category Vendors have history |
| ‘10000 EUR’ & vendor_category = ‘silver’ | | of processing high valued |
| | | orders. |
| If current_step = ‘Send to Partner’ & | Process Ends— | Only Platinum Category |
| product_category = ‘IT’ & amount > | Order Rejected | Vendors have history of |
| ‘20000 EUR’ & vendor_category != | | processing high valued orders. |
| ‘Platinum’ | | |
| If current_step = ‘Send to Partner’ & | Order Confirmed | |
| product_category = ‘IT’ & | | |
| vendor_category = ‘Platinum’ | | |
| If current_step = ‘Send to Partner’ & | Order Confirmed | |
| product_category = ‘IT’ & | | |
| vendor_category = ‘Gold’ & amount < | | |
| ‘20000 EUR’ | | |
| If current_step = ‘Send to Partner’ & | Order Confirmed | |
| product_category = ‘IT’ & | | |
| vendor_category = ‘Silver & amount < | | |
| ‘10000 EUR’ | | |

The AI Data Attribute Recommendation Service 480 may be a platform service. The DAR service 480 may provide machine learning models for consuming service and may provide capabilities to train models, taking input dataset.

The Process Visibility service 490 may store snapshots of data for all the steps and activities for process execution. The snapshots may also capture a changelog of the data that is created or modified during the process execution. This data may be used as input to create and train the machine learning model.

The input data used for training the machine learning model may be cured to remove duplicates, incomplete instances and persisted per process activity. The input data, once cleansed, may be grouped per process activity. It may include information about the process data, the status of activity, timestamp, and execution instance, for example.

An example dataset for training the machine learning model is provided below. This example dataset corresponds to the purchase order example described above with respect to FIG. 1.

| PROCESS_{—} | ACTIVITY_{—} | | EVENT_{—} | | | |
|---|---|---|---|---|---|---|
| DEFINITION_ID | DEFINITION_ID | TIMESTAMP | NAME | PR_ID | PRD_CAT | PRD_AMT |
| O2C | Purchase_{—} | 2017-10- | Started | PR10001 | IT | 12500 |
| | request_{—} | 04T13:43:31Z | | | | |
| | Creation | | | | | |
| O2C | Purchase_{—} | 2017-10- | Completed | PR10001 | IT | 12500 |
| | request_{—} | 05T13:43:31Z | | | | |
| | Creation | | | | | |
| O2C | Vendor_{—} | 2017-10- | Started | PR10001 | IT | 12500 |
| | Selection | 11T13:43:31Z | | | | |
| O2C | Vendor_{—} | 2017-10- | Completed | PR10001 | IT | 12500 |
| | Selection | 12T17:43:31Z | | | | |
| O2C | Send_to_{—} | 2017-10- | Started | PR10001 | IT | 12500 |
| | Partner | 12T17:43:31Z | | | | |
| O2C | Send_to_{—} | 2017-10- | Completed | PR10001 | IT | 12500 |
| | Partner | 13T09:43:31Z | | | | |
| O2C | Order_{—} | 2017-10- | Started | PR10001 | IT | 12500 |
| | Confirmed | 19T13:43:31Z | | | | |
| O2C | Order_{—} | 2017-10- | Completed | PR10001 | IT | 12500 |
| | Confirmed | 22T10:03:31Z | | | | |
| O2C | Invoice_{—} | 2017-10- | Started | PR10001 | IT | 12500 |
| | Generated | 23T:13:43:31Z | | | | |
| O2C | Invoice_{—} | 2017-10- | Completed | PR10001 | IT | 12500 |
| | Generated | 29T11:29:31Z | | | | |
| O2C | Delivery | 2017-10- | Started | PR10001 | IT | 12500 |
| | | 23T13:43:30Z | | | | |
| O2C | Delivery | 2017-10- | Completed | PR10001 | IT | 12500 |
| | | 25T09:25:30Z | | | | |
| O2C | Payment | 2017-11- | Started | PR10001 | IT | 12500 |
| | | 10T04:13:07Z | | | | |
| O2C | Payment | 2017-11- | Completed | PR10001 | IT | 12500 |
| | | 12T00:32:07Z | | | | |

| PROCESS_{—} | ORD_{—} | | | | | |
|---|---|---|---|---|---|---|
| DEFINITION_ID | ITEM_QTY | PO_ID | PO_STS | TRANS_TS | VEN_ID | VEN_CAT |
| O2C | 18 | | | | | |
| O2C | 18 | | | | | |
| O2C | 18 | | | | | |
| O2C | 18 | | | | | |
| O2C | 18 | | | | V10001 | GOLD |
| O2C | 18 | | | | V10001 | GOLD |
| O2C | 18 | PO10001 | | | V10001 | GOLD |
| O2C | 18 | PO10001 | ACCEPTED | | V10001 | GOLD |
| O2C | 18 | PO10001 | ACCEPTED | | V10001 | GOLD |
| O2C | 18 | PO10001 | ACCEPTED | 2017-10-29 | V10001 | GOLD |
| O2C | 18 | PO10001 | ACCEPTED | | V10001 | GOLD |
| O2C | 18 | PO10001 | ACCEPTED | 2017-10-25 | V10001 | GOLD |
| O2C | 18 | PO10001 | ACCEPTED | | V10001 | GOLD |
| O2C | 18 | PO10001 | ACCEPTED | 2017-11-12 | V10001 | GOLD |

A supervised learning algorithm may be used as the historical data set has input and output values for a given process step. The Model selection step can be handled by the DAR service 480 or users can define a particular algorithm to be used based on the process context. As discussed herein, the machine learning model predicts the output variables for a given process step based on the provided input variables.

### Example Hardware

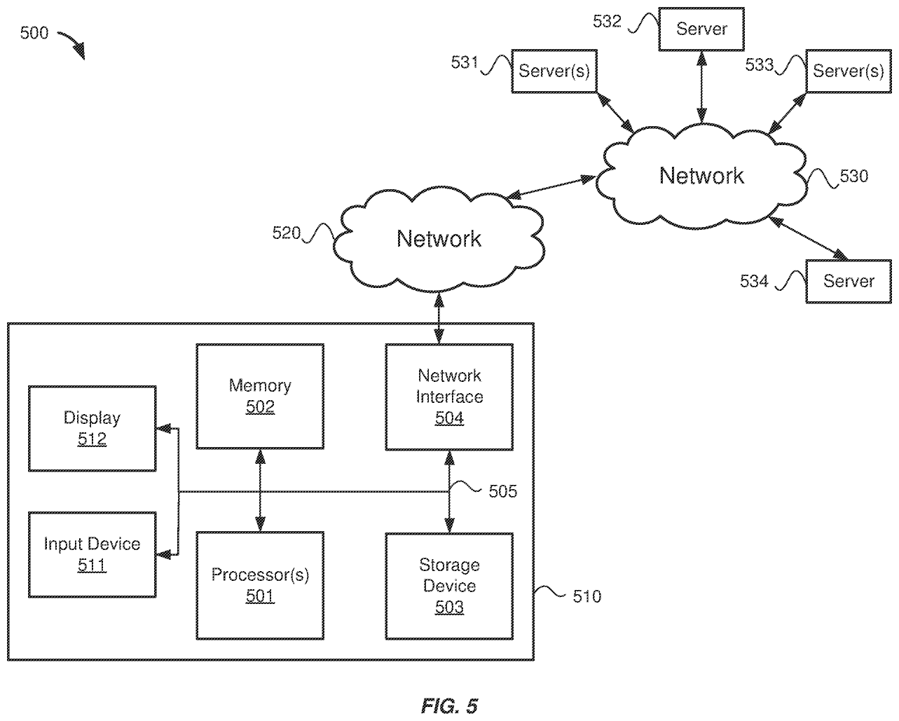

FIG. 5 shows a diagram 500 of hardware of a special purpose computing machine for implementing systems and methods described herein. The following hardware description is merely one example. It is to be understood that a variety of computers topologies may be used to implement the above described techniques. The hardware shown in FIG. 5 may be used to implement the computer systems and computer software (computer reprogram code) described herein.

The computer system 510 includes a bus 505 or other communication mechanism for communicating information, and one or more processor(s) 501 coupled with bus 505 for processing information. The computer system 510 also includes a memory 502 coupled to bus 505 for storing information and instructions to be executed by processor 501, including information and instructions for performing some of the techniques described above, for example. This memory may also be used for storing programs executed by processor(s) 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 503 may include source code, binary code, or software files for performing the techniques above, for example. Storage device and memory are both examples of non-transitory computer readable storage mediums.

The computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses, for example.

The computer system also includes a network interface 504 coupled with bus 505. The network interface 504 may provide two-way data communication between computer system 510 and a network 520. The network interface 504 may be a wireless or wired connection, for example. The network 520 may be a local area network or an intranet, for example. The computer system 510 can send and receive information through the network interface 504, across the network 520, to computer systems connected to the Internet 530. Using the Internet 530 the computer system 510 may access data and features that reside on multiple different hardware servers 531-534. The servers 531-534 may be part of a cloud computing environment in some embodiments.

### Example Embodiments

Various example embodiments implementing the techniques discussed above are described below.

In some aspects, the techniques described herein relate to a computer system, including: one or more processors; one or more machine-readable medium coupled to the one or more processors and storing computer program code including sets instructions executable by the one or more processors to: obtain a process model of a process, the process model including inputs, outputs, and attributes for a plurality of process steps; determine unique branches between particular steps of the plurality of process steps and conditions for the attributes associated with the unique branches by traversing the process model; determine decision logic based on the unique branches and the conditions, the decision logic outputting a next step based on a current step of the process, a previous path traversed, the attributes, and the conditions for the attributes; obtain information on a current step of an instance of the process and a previous path traversed for the instance of the process; determine a predicted output value for the current step of the instance of the process by providing the information on the current step of the instance and the previous path traversed for the instance to a machine learning model; determine a next step for the instance of the process using the decision logic and the predicted output value; determine a predicted process flow through the plurality of process steps for the instance of the process by iteratively determining subsequent steps for the instance by predicting output values using the machine learning model and determining the following step using the decision logic until reaching an end of the instance of the process; and present the predicted process flow in a user interface along with the predicted output values and conditions.

In some aspects, the techniques described herein relate to a computer system, wherein the computer program code further includes sets instructions executable by the one or more processors to: obtain input via the user interface to adjust the attributes of the instance of the process; determine another predicted process flow through the plurality of process steps for the instance of the process using the attributes as adjusted, the other predicted process flow being different than the original predicted process flow; presenting the other predicted process flow in the user interface along with the predicted output values and conditions.

In some aspects, the techniques described herein relate to a computer system, wherein the input adjusts the attributes of the instance of the process without modifying the process model.

In some aspects, the techniques described herein relate to a computer system, wherein the computer program code further includes sets instructions executable by the one or more processors to: obtain execution logs and historical data for a plurality of historical process instances of the process model; and initiate training of the machine learning model using the execution logs and historical data.

In some aspects, the techniques described herein relate to a computer system, wherein the execution logs and historical data for the plurality of historical process instances include statuses, timestamps, input values, and output values for the plurality of process steps, wherein the machine learning model predicts output values for a particular process step based on provided input values.

In some aspects, the techniques described herein relate to a computer system, wherein the computer program code further includes sets instructions executable by the one or more processors to: remove duplicates and incomplete instances from the execution logs and historical data to obtain cleansed training data; and group the cleansed training data per process step of the plurality of process step, wherein the training of the machine learning model uses the cleansed training data grouped per process step.

In some aspects, the techniques described herein relate to a computer system, wherein the computer program code further includes sets instructions executable by the one or more processors to: provide a notification regarding the predicted process flow for the process instance in the user interface.

In some aspects, the techniques described herein relate to one or more non-transitory computer-readable medium storing computer program code including sets of instructions to: obtain a process model of a process, the process model including inputs, outputs, and attributes for a plurality of process steps; determine unique branches between particular steps of the plurality of process steps and conditions for the attributes associated with the unique branches by traversing the process model; determine decision logic based on the unique branches and the conditions, the decision logic outputting a next step based on a current step of the process, a previous path traversed, the attributes, and the conditions for the attributes; obtain information on a current step of an instance of the process and a previous path traversed for the instance of the process; determine a predicted output value for the current step of the instance of the process by providing the information on the current step of the instance and the previous path traversed for the instance to a machine learning model; determine a next step for the instance of the process using the decision logic and the predicted output value; determine a predicted process flow through the plurality of process steps for the instance of the process by iteratively determining subsequent steps for the instance by predicting output values using the machine learning model and determining the following step using the decision logic until reaching an end of the instance of the process; and present the predicted process flow in a user interface along with the predicted output values and conditions.

In some aspects, the techniques described herein relate to a non-transitory computer-readable medium, wherein the computer program code further includes sets of instructions to: obtain input via the user interface to adjust the attributes of the instance of the process; determine another predicted process flow through the plurality of process steps for the instance of the process using the attributes as adjusted, the other predicted process flow being different than the original predicted process flow; present the other predicted process flow in the user interface along with the predicted output values and conditions.

In some aspects, the techniques described herein relate to a non-transitory computer-readable medium, wherein the input adjusts the attributes of the instance of the process without modifying the process model.

In some aspects, the techniques described herein relate to a non-transitory computer-readable medium, wherein the computer program code further includes sets of instructions to: obtain execution logs and historical data for a plurality of historical process instances of the process model; and initiate training of the machine learning model using the execution logs and historical data.

In some aspects, the techniques described herein relate to a non-transitory computer-readable medium, wherein the execution logs and historical data for the plurality of historical process instances include statuses, timestamps, input values, and output values for the plurality of process steps, wherein the machine learning model predicts output values for a particular process step based on provided input values.

In some aspects, the techniques described herein relate to a non-transitory computer-readable medium, wherein the computer program code further includes sets of instructions to: remove duplicates and incomplete instances from the execution logs and historical data to obtain cleansed training data; and group the cleansed training data per process step of the plurality of process step, wherein the training of the machine learning model uses the cleansed training data grouped per process step.

In some aspects, the techniques described herein relate to a non-transitory computer-readable medium, wherein the computer program code further includes sets of instructions to: provide a notification regarding the predicted process flow for the process instance in the user interface.

In some aspects, the techniques described herein relate to a computer-implemented method, including: obtaining a process model of a process, the process model including inputs, outputs, and attributes for a plurality of process steps; determining unique branches between particular steps of the plurality of process steps and conditions for the attributes associated with the unique branches by traversing the process model; determining decision logic based on the unique branches and the conditions, the decision logic outputting a next step based on a current step of the process, a previous path traversed, the attributes, and the conditions for the attributes; obtaining information on a current step of an instance of the process and a previous path traversed for the instance of the process; determining a predicted output value for the current step of the instance of the process by providing the information on the current step of the instance and the previous path traversed for the instance to a machine learning model; determining a next step for the instance of the process using the decision logic and the predicted output value; determining a predicted process flow through the plurality of process steps for the instance of the process by iteratively determining subsequent steps for the instance by predicting output values using the machine learning model and determining the following step using the decision logic until reaching an end of the instance of the process; and presenting the predicted process flow in a user interface along with the predicted output values and conditions.

In some aspects, the techniques described herein relate to a computer-implemented method, further including: obtaining input via the user interface to adjust the attributes of the instance of the process; determining another predicted process flow through the plurality of process steps for the instance of the process using the attributes as adjusted, the other predicted process flow being different than the original predicted process flow; presenting the other predicted process flow in the user interface along with the predicted output values and conditions.

In some aspects, the techniques described herein relate to a computer-implemented method, wherein the input adjusts the attributes of the instance of the process without modifying the process model.

In some aspects, the techniques described herein relate to a computer-implemented method, further including: obtaining execution logs and historical data for a plurality of historical process instances of the process model; and initiating training of the machine learning model using the execution logs and historical data.

In some aspects, the techniques described herein relate to a computer-implemented method, wherein the execution logs and historical data for the plurality of historical process instances include statuses, timestamps, input values, and output values for the plurality of process steps, wherein the machine learning model predicts output values for a particular process step based on provided input values.

In some aspects, the techniques described herein relate to a computer-implemented method, further including: providing a notification regarding the predicted process flow for the process instance in the user interface. Rule Based Process Flow Prediction Decision logic is determined based on unique branches and the conditions between steps of a process model. The decision logic outputs a next step based on a current step of the process, a previous path traversed, the attributes, and the conditions for the attributes. For a particular instance of the process, a current step a predicted output value for a current step of the instance is determined by providing information on the current step of the instance and a previous path traversed for the instance to a machine learning model. A next step of the process is determined using the decision logic and the predicted output value. A predicted process flow through the plurality of process steps for the instance is determined by iteratively determining subsequent steps for the instance using the machine learning model and the decision logic until reaching an end of the instance of the process.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system, comprising:
one or more processors;
one or more machine-readable medium coupled to the one or more processors and storing computer program code comprising sets of instructions executable by the one or more processors to:
obtain a process model of a process, the process model comprising inputs, outputs, and attributes for a plurality of process steps;
determine unique branches between particular steps of the plurality of process steps and conditions for the attributes associated with the unique branches by traversing the process model;
determine decision logic based on the unique branches and the conditions, the decision logic outputting a next step based on a current step of the process, a previous path traversed, the attributes, and the conditions for the attributes;
obtain information on a current step of an instance of the process and a previous path traversed for the instance of the process;
determine a predicted output value for the current step of the instance of the process by providing the information on the current step of the instance and the previous path traversed for the instance to a machine learning model;
determine a next step for the instance of the process using the decision logic and the predicted output value;
determine a predicted process flow through the plurality of process steps for the instance of the process by iteratively determining subsequent steps for the instance by predicting output values using the machine learning model and determining a following step using the decision logic until reaching an end of the instance of the process; and
present the predicted process flow in a user interface along with the predicted output values and conditions.

2. The computer system of claim 1, wherein the computer program code further comprises sets of instructions executable by the one or more processors to:
obtain input via the user interface to adjust the attributes of the instance of the process;
determine an other predicted process flow through the plurality of process steps for the instance of the process using the attributes as adjusted, the other predicted process flow being different than the predicted process flow; and
present the other predicted process flow in the user interface along with the predicted output values and conditions.

3. The computer system of claim 2, wherein the input adjusts the attributes of the instance of the process without modifying the process model.

4. The computer system of claim 1, wherein the computer program code further comprises sets instructions executable by the one or more processors to:
obtain execution logs and historical data for a plurality of historical process instances of the process model; and
initiate training of the machine learning model using the execution logs and historical data.

5. The computer system of claim 4, wherein the execution logs and historical data for the plurality of historical process instances include statuses, timestamps, input values, and output values for the plurality of process steps, wherein the machine learning model predicts output values for a particular process step based on provided input values.

6. The computer system of claim 4, wherein the computer program code further comprises sets instructions executable by the one or more processors to:
remove duplicates and incomplete instances from the execution logs and historical data to obtain cleansed training data; and
group the cleansed training data per process step of the plurality of process step, wherein the training of the machine learning model uses the cleansed training data grouped per process step.

7. The computer system of claim 1, wherein the computer program code further comprises sets instructions executable by the one or more processors to:
provide a notification regarding the predicted process flow for the process instance in the user interface.

8. One or more non-transitory computer-readable medium storing computer program code comprising sets of instructions to:
obtain a process model of a process, the process model comprising inputs, outputs, and attributes for a plurality of process steps;
determine unique branches between particular steps of the plurality of process steps and conditions for the attributes associated with the unique branches by traversing the process model;
determine decision logic based on the unique branches and the conditions, the decision logic outputting a next step based on a current step of the process, a previous path traversed, the attributes, and the conditions for the attributes;
obtain information on a current step of an instance of the process and a previous path traversed for the instance of the process;
determine a predicted output value for the current step of the instance of the process by providing the information on the current step of the instance and the previous path traversed for the instance to a machine learning model;
determine a next step for the instance of the process using the decision logic and the predicted output value;
determine a predicted process flow through the plurality of process steps for the instance of the process by iteratively determining subsequent steps for the instance by predicting output values using the machine learning model and determining a following step using the decision logic until reaching an end of the instance of the process; and
present the predicted process flow in a user interface along with the predicted output values and conditions.

9. The non-transitory computer-readable medium of claim 8, wherein the computer program code further comprises sets of instructions to:
obtain input via the user interface to adjust the attributes of the instance of the process;
determine an other predicted process flow through the plurality of process steps for the instance of the process using the attributes as adjusted, the other predicted process flow being different than the predicted process flow; and
present the other predicted process flow in the user interface along with the predicted output values and conditions.

10. The non-transitory computer-readable medium of claim 9, wherein the input adjusts the attributes of the instance of the process without modifying the process model.

11. The non-transitory computer-readable medium of claim 8, wherein the computer program code further comprises sets of instructions to:
obtain execution logs and historical data for a plurality of historical process instances of the process model; and
initiate training of the machine learning model using the execution logs and historical data.

12. The non-transitory computer-readable medium of claim 11, wherein the execution logs and historical data for the plurality of historical process instances include statuses, timestamps, input values, and output values for the plurality of process steps, wherein the machine learning model predicts output values for a particular process step based on provided input values.

13. The non-transitory computer-readable medium of claim 11, wherein the computer program code further comprises sets of instructions to:
remove duplicates and incomplete instances from the execution logs and historical data to obtain cleansed training data; and
group the cleansed training data per process step of the plurality of process step, wherein the training of the machine learning model uses the cleansed training data grouped per process step.

14. The non-transitory computer-readable medium of claim 8, wherein the computer program code further comprises sets of instructions to:
provide a notification regarding the predicted process flow for the process instance in the user interface.

15. A computer-implemented method, comprising:
obtaining a process model of a process, the process model comprising inputs, outputs, and attributes for a plurality of process steps;
determining unique branches between particular steps of the plurality of process steps and conditions for the attributes associated with the unique branches by traversing the process model;
determining decision logic based on the unique branches and the conditions, the decision logic outputting a next step based on a current step of the process, a previous path traversed, the attributes, and the conditions for the attributes;
obtaining information on a current step of an instance of the process and a previous path traversed for the instance of the process;
determining a predicted output value for the current step of the instance of the process by providing the information on the current step of the instance and the previous path traversed for the instance to a machine learning model;
determining a next step for the instance of the process using the decision logic and the predicted output value;
determining a predicted process flow through the plurality of process steps for the instance of the process by iteratively determining subsequent steps for the instance by predicting output values using the machine learning model and determining a following step using the decision logic until reaching an end of the instance of the process; and
presenting the predicted process flow in a user interface along with the predicted output values and conditions.

16. The computer-implemented method of claim 15, further comprising:
obtaining input via the user interface to adjust the attributes of the instance of the process;
determining an other predicted process flow through the plurality of process steps for the instance of the process using the attributes as adjusted, the other predicted process flow being different than the predicted process flow; and
presenting the other predicted process flow in the user interface along with the predicted output values and conditions.

17. The computer-implemented method of claim 16, wherein the input adjusts the attributes of the instance of the process without modifying the process model.

18. The computer-implemented method of claim 15, further comprising:
obtaining execution logs and historical data for a plurality of historical process instances of the process model; and
initiating training of the machine learning model using the execution logs and historical data.

19. The computer-implemented method of claim 18, wherein the execution logs and historical data for the plurality of historical process instances include statuses, timestamps, input values, and output values for the plurality of process steps, wherein the machine learning model predicts output values for a particular process step based on provided input values.

20. The computer-implemented method of claim 15, further comprising:
providing a notification regarding the predicted process flow for the process instance in the user interface.
